(19) United States
(12) Patent Application Publication
(10) Pub. No.: US 2008/0086450 A1
(43) Pub. Date: Apr. 10, 2008

(54) Interface for on-line database and patent searching

(76) Inventor: Steven Noel Bittenson, Bedford, MA (US)

Correspondence Address: STEVEN N. BITTENSON, 10 CARIBOU STREET, BEDFORD, MA, 01730-1921, US

(21) Appl. No.: 11/538,793

(22) Filed: Oct. 4, 2006

(51) Int. Cl. G06F 17/30

(52) U.S. Cl. 707/3

(57) ABSTRACT

Interfaces, systems and methods for searching a plurality of electronic databases, including patent databases. Downloaded database records can be adapted to a common format that includes hyperlinks to respective databases. Software for manipulating one or more of the database records is accessed via a chordal interface, wherein selection of individual software buttons and concurrent selection of two or more software buttons in a two-dimensional array of buttons is interpreted contextually.

### FIELD OF THE INVENTION

This invention relates generally to graphical user interfaces for use with computers and computer workstations. More particularly, this invention relates to user interfaces for searching and processing information from electronic databases.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Many critical business activities are supported by prior art intellectual property searches. These business activities often focus on the preparation and prosecution of patent applications, but can also include diligence efforts associated with new product development, competitive assessments, asset acquisitions, strategic business decisions, the selection of research directions, and other activities. A large and increasing fraction of prior art searches are performed using personal computers or other computer workstations to access electronic databases made available via the internet by the United States Patent and Trademark Office (USPTO), the World Intellectual Property Organization (WIPO), the European Patent Office (EPO) and many other patent offices worldwide.

Search capabilities, as well as search protocols, syntax and data formats, vary widely among these on-line resources. Even among different databases maintained by a single patent office or other organization, these features can vary. For example, a search string used for performing an advanced search of the USPTO issued patent database may require modification for use in searching for parallel information from the WIPO database, or from the USPTO published application database.

Another challenge associated with on-line prior art searching is that although some publicly accessible databases provide excellent primary resources for patent searching, it can be awkward and time consuming to coordinate searching among multiple databases, as well as to effectively record, organize, and report search results, even from a single on-line database. In addition, some public on-line databases are heavily subscribed and sometimes subject to slow or delayed internet access. Especially when a search must be performed under a time constraint, inefficient execution of basic but necessary component tasks of searching can significantly compromise the searcher's ability to focus on important high-level tasks such as assessing relationships among references, or identifying correspondences between a reference and a subject invention, product or document.

Several corporations have established private on-line patent databases that collect data from multiple public databases, but access to these secondary data sources is generally expensive, particularly when many access locations (seats or workstations) are required to conduct the search efforts of an organization. In addition, subscription to a commercial database may be subject to contractual restrictions regarding the sharing of database access, or regarding the distribution or resale of downloaded documents. Commercial databases may also be considered less trusted resources than primary databases, such as those provided by national or international patent offices. Thus there is a need for improved efficiency and effectiveness in accessing and searching primary on-line patent databases, and an associated need to support the organizational and reporting requirements of intellectual property searching.

### SUMMARY OF THE INVENTION

Disclosed herein are graphical user interfaces, systems and methods for database access, searching and report generation, including efficient coordination of the searching of a plurality of electronic databases. The interfaces, systems and methods of the present invention are described herein primarily in terms of on-line patent searching, but are equally applicable for accessing any electronic, searchable databases, and even more generally for accessing or manipulating any data that can be represented in a chart, list, or matrix format.

One aspect of the present invention is a graphical user interface. The interface includes a workspace for displaying a plurality of database records, and a plurality of software buttons positioned adjacent to the workspace and defining a two-dimensional button array. In an embodiment the database records are downloaded from one or more electronic database. A software button of the array is adapted for concurrent selection with a first adjacent button of the array for calling a first software routine. The first software routine performs an operation for manipulating one or more database record in the workspace. The software button is also adapted for concurrent selection with a second adjacent button of the array, for calling a second software routine. The second software routine performs an operation different from the first routine for manipulating one or more database record in the workspace.

The button array can be rectangular or can have another two-dimensional shape. In some embodiments, three or more software buttons can be selected concurrently to provide access to additional software routines for performing other operations on the workspace, for example, by manipulating one or more database record therein. In an embodiment, concurrent selection of buttons in a rectangular button array includes selection of buttons along a horizontal line in the array, along a vertical line in the array, and a rectangular selection of buttons in the array.

The graphical user interface can be a software module within another computer program, or can be an independent computer program. In an embodiment, the graphical user interface is a module that operates within a spreadsheet programming environment. The one or more on-line database can include patent databases and other types of databases. In one embodiment, the one or more database includes at least four on-line databases.

In an embodiment, the interface includes a substantially rectangular workspace for viewing and manipulating a vertical array of database records placed in the workspace from the one or more on-line database. A database record can be any data originating in the one or more on-line database and associated with a document stored in the one or more on-line database. The record can include reference information that can be a hyperlink for returning to the database to inspect the document, or other information. In one embodiment, the workspace has a vertical edge. A plurality of software buttons defining a substantially rectangular button array is positioned adjacent to the vertical edge. In a further embodiment, each of the workspace and the button array is a vertically elongated rectangle. The vertically elongated rectangle can be vertically extendible to accommodate additions of database records to the workspace. In other embodiments, one or both of the workspace and the button array have another shape.

Software buttons are defined herein as a location or a graphical element in a graphical user interface (GUI) that is selectable using a computer input device to call one or more of software statements, collections of statements, programs, or subroutines (herein collectively called software or software routines) that execute functions of the GUI. The term call is used herein to mean providing a software command to initiate execution of software. In an embodiment, a software button comprises one or more spreadsheet cell, the selection of which calls software. The software can be written in any software language suitable for controlling a GUI. The plurality of buttons is adapted for individual selection of a button, and for selection of a button concurrently (in combination) with one or more additional button, to call software for selectively manipulating one or more record of the array of records. Two or more software buttons that are selectable concurrently to selectively call software is herein called a chord, and selection of the two or more software buttons concurrently is herein called chordal selection. In an embodiment, chords comprise two or more adjacent buttons in the button array.

In one embodiment, manipulating the one or more record includes one or more of generating a hyperlink between the record and one of the one or more database, redirecting a hyperlink from one to another of the one or more database, following a hyperlink directed to one of the one or more database, removing a hyperlink to one of the one or more database, formatting the one or more record in the workspace, repositioning one or more record within the workspace, deleting the one or more record from the workspace, and copying a portion of one or more record.

The button array can include a plurality of horizontal rows of buttons, each row being associated with a corresponding record of the plurality of records in the workspace. The button array can include two or more vertical columns of buttons, each column being associated with software for manipulating one or more record of the vertical array of records. The two or more columns can be visually distinct from one another. In an embodiment, the two or more columns are color-coded. Each column can be visually continuous or discontinuous along the vertical direction.

In various embodiments, chordal selection for manipulating data in the workspace includes concurrent selection of two or more buttons horizontally, vertically, or in a rectangular array. The interface can also include one or more software button for calling software for publishing a formatted search report. The plurality of buttons can be adapted for selection using any type of physically connected or wireless input device. In various embodiments, the computer input device is a computer mouse, a trackball, a wireless pointer, a graphic input tablet or a touch-sensitive display.

Another aspect of the present invention is a software interface for accessing and searching a plurality of intellectual property databases. The interface includes a substantially rectangular workspace for holding a plurality of records downloaded from one or more of the plurality of databases. The workspace has a vertical edge. At least two mutually adjacent vertically elongated arrays of software buttons are positioned substantially parallel to the vertical edge. Each array is adapted for individual and for chordal selection of one or more button of the arrays, for manipulating one or more of the plurality of records within the workspace. A system of the present invention for facilitating database searching includes an interface of the present invention installed on a computer workstation having electronic access to the plurality of databases.

Yet another aspect of the present invention is a method for searching one or more on-line electronic database. The method includes providing a computer workstation and a graphical interface of the present invention installed on the workstation. The interface includes a workspace, a plurality of software control buttons positioned adjacent to the workspace, and a first hyperlink to a database of the one or more on-line database. The method further includes recording a search string in a text entry window of the interface, selecting the first hyperlink to copy the search string to the database, and searching the database using the search string. The method also includes copying one or more database record identified by searching the database, from the database to the workspace, and generating a second hyperlink in the workspace. The second hyperlink links the one or more record to the corresponding database. In an embodiment, generating the second hyperlink includes selecting one or more of the plurality of buttons. The method further includes inspecting one the one or more of documents by selecting the second hyperlink.

### BRIEF DESCRIPTION OF THE DRAWINGS

This invention is described with particularity in the appended claims. The above and further aspects of this invention may be better understood by referring to the following description in conjunction with the accompanying exemplary drawings, in which like numerals indicate like elements and features in various figures. The drawings are not necessarily to scale, emphasis instead being placed upon illustrating the principles of the invention.

FIG. 1 illustrates a block diagram of an exemplary embodiment of a graphical user interface (GUI) of the present invention.

FIG. 2 illustrates an exemplary embodiment of a workspace and a discrete software button array of the present invention.

FIG. 3 illustrates an exemplary embodiment of a workspace and software button array of the present invention, with columns of buttons graphically represented as vertical bars.

FIG. 4 illustrates an exemplary embodiment of an upper section of a GUI of the present invention.

FIG. 5 illustrates an exemplary embodiment of a search report generated using a GUI of the present invention

### DETAILED DESCRIPTION

The present invention provides novel graphical user interfaces (GUIs), systems and methods for searching and analyzing data from a plurality of on-line databases. An on-line database can be any electronic database that is accessible from a personal computer or from a computer workstation, using any means for electronic access. The on-line database can be electronically accessible on a local computer, a local area network, a wide area network, via an internet connection, or using another form of electronic access, hard-wired or wireless. The present invention also provides tools for organizing and recording search results, as well as support for the concurrent handling of a plurality of searches. Although emphasis is placed herein on prior art patent searching, the interfaces, systems and methods of the present invention can be applied to any type of database searching and analysis.

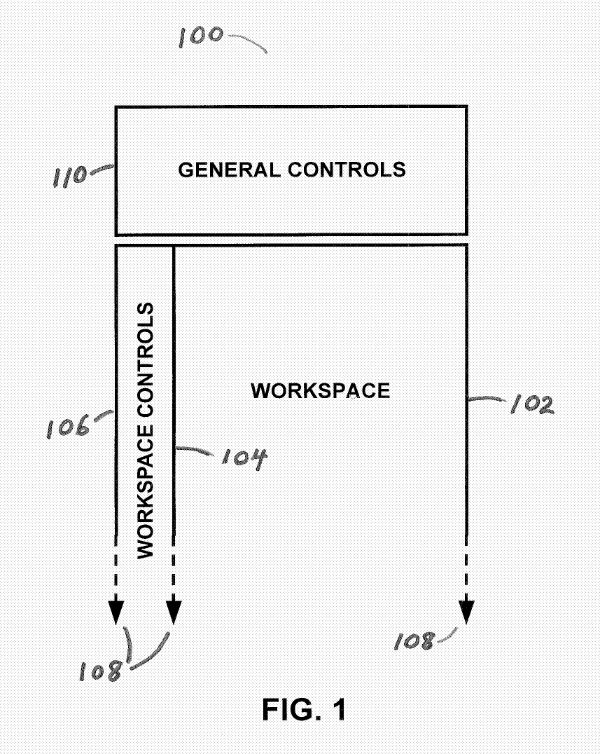

Referring more particularly to the figures, FIG. 1 illustrates as a block diagram, an exemplary embodiment of a graphical user interface (GUI) 100 of the present invention. The GUI 100 includes a substantially rectangular workspace 102 for holding and manipulating data records, for example, records downloaded from an on-line database. The workspace can also include category headers (titles) for sorting records in the array, database search strings, annotation, and other data for supporting the performance and organization of a database search. The workspace 102 is seen to have a vertical edge 104. The vertical edge 104 can be marked graphically in the GUI by a visible line as illustrated in FIG. 1, by another type of graphical separator, or without a specific graphical marking.

A vertically elongated workspace control area 106 is positioned parallel and substantially adjacent to the vertical edge 104, for manipulating data in the workspace 102. In an embodiment, the workspace control area 106 and the workspace 102 are unbounded in a vertical direction, as indicated by arrows 108 in FIG. 1. That is, the workspace 102 and the workspace control area 106 are vertically extendable to accommodate data added to the workspace 102. In an embodiment, the GUI 100 operates within a spreadsheet program and the vertical extent of the workspace 102 and the workspace control area 106 are limited by a maximum size of a spreadsheet within the spreadsheet program. In one embodiment, the maximum size includes at least 10,000 rows of data. In another embodiment, the maximum size includes approximately 65,500 rows. In an embodiment, the workspace control area 106 includes a plurality of software buttons for calling software to manipulate data positioned in the workspace. The plurality of buttons can also provide access to on-line databases via hyperlinks.

The GUI 100 can also include a general control area 110 for global control of the GUI 100. For example, the general control area can include one or more of text entry windows and software buttons for calling control software. Exemplary windows in the one or more general control area 110 include windows for entering a search title, searcher identification, search strings, and dates. Exemplary software buttons include buttons for calling editing software, data processing software, and hyperlinks for accessing on-line search databases. Examples of data processing software called from the one or more general control area can include software for date calculations, for identification of duplicates among records in the workspace, for publishing a search report, for switching among a plurality of ongoing searches, and for clearing a search or starting a new search. In an embodiment, selecting a hyperlink calls software that places data into a clipboard for copying that data or information derived from that data, to a text entry window of an on-line database.

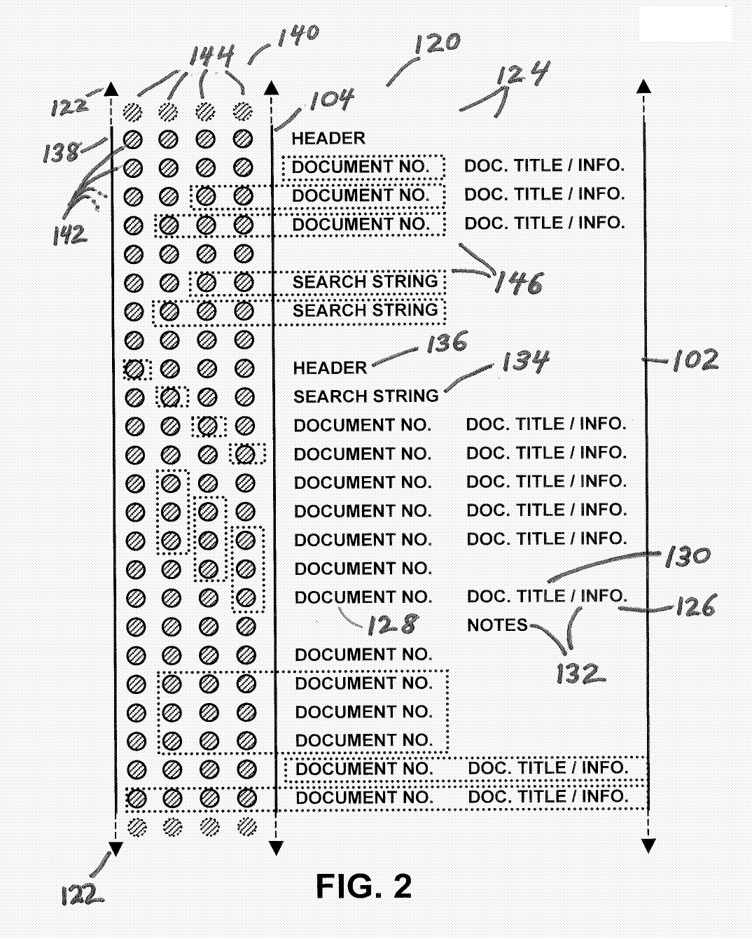

A vertical segment 120 of the workspace 100 is illustrated in FIG. 2. The vertical segment 120 is a vertical portion of the workspace 102, as indicated by continuation arrows 122 at the top and bottom the vertical segment 120. Various types of data can be placed (entered, or copied from another location) into and manipulated in the workspace 102. For descriptive purposes only herein, illustrative, non-limiting data 124 is included in FIG. 2 through FIG. 5. One type of data comprises a database record 126 that includes one or more data element 128, 130, 132. In an embodiment, database elements include one or more of a document number 128 and a document title 130. In an embodiment the document number 128 is one of a patent number, a publication number and a patent application number. In an embodiment, the document number 128 is associated with a hyperlink to an on-line database so that selecting the document number 128 in the workspace 102 activates the hyperlink. In an embodiment, the document number 128 and the title 130 are positioned in separate spreadsheet cells in a row of a spreadsheet. In another embodiment, additional information or annotation 132 is included in the database record 126. Examples of additional information include assignee information, patent family information, and searcher's notes. In one embodiment, the additional information or annotation is appended to the document title 130. In another embodiment, the additional information or annotation is positioned adjacent to the title 130. In an embodiment, the data elements occupy a plurality of spreadsheet cells in one or more row of a spreadsheet.

Another type of data that can be placed and manipulated in the vertical segment 120 is a search string 134. In an embodiment, the search string 134 is a search string for searching an on-line patent database. Yet another type of data that can be placed and manipulated in the vertical segment 120 is a textual header 136 for classifying or sorting other types of data, for example, database records that have been placed in the workspace 102.

FIG. 2 also illustrates an embodiment of a discrete button-type workspace control area 138 positioned adjacent and parallel to the vertical edge 104. The discrete button control area 138 includes a vertically extended, substantially rectangular array 140 of software control buttons 142. The rectangular array 140 includes two or more columns 144 of buttons 142. In an embodiment, the rectangular array 140 includes four columns 144 of buttons 142. That is, the array 140 includes a plurality of rows of four buttons 142 per row. Each button 142 in the array 140 has an individual function, that is, button selection using a computer input device calls software for manipulating data in the workspace 102. Any suitable input device can be used for button selection. Exemplary input devices, also called pointing devices, include a computer mouse, a trackball, a graphics tablet, a touchscreen, and a wireless pointer.

In an embodiment, all buttons 142 in a selected column 144 share a common software call, with a selected button 142 in the column 144 adapted to call software for manipulating one or more data element of a database record 126 horizontally aligned with (for example, in the same spreadsheet row as) the selected button 142. Examples of manipulating data in the workspace 102 by selecting individual software buttons 142 include deleting a row of data, inserting an empty row, transferring a row of data to a storage register, restoring a row of data from a storage register to the workspace, following a hyperlink to a database that holds a document referenced by the data selecting an entire row of data, and formatting one or more row of data in the workspace 102.

In an embodiment, groups of buttons can also be selected concurrently (chordally) to call software different from software called by selecting an individual button 142. In an embodiment, the selection of two or more buttons includes holding a mouse button (or analogous input means) on an input device while dragging across the two or more buttons. A selection of software that is called by chordal selection is determined by one or more of: the number of buttons (for example, the number of rows or number of columns) in the chord, the horizontal and vertical position of the chord, the orientation of the chord, for example, horizontal (along a row) or vertical (along a column), and a type of data (text, numerical, hyperlink) selected with the chord. Illustrative examples of software functions called by chordal selection include selecting a number of rows to be deleted, inserted, replaced, or selected. Other examples include redirecting a hyperlink from one database to another database, and creating or removing a hyperlink from the workspace 102.

The inclusion of individual button and chordal calls of software provides access to a greater number of software routines for manipulating data in the workspace 102 than can be called by single button selection only, while maintaining a visually uncluttered interface. For example, chordal combinations of two or more adjacent buttons selected among a total of four buttons in a line includes ten possible chords. In general, a number N of buttons in a line can provide N(N+1)/2 different selections, including chords and individual buttons to call software. In addition, the type of software called by a chordal selection can be programmed to be conditional upon the type of data in a corresponding record in the workspace, further increasing functionality without increasing the visual complexity of the interface.

In an illustrative embodiment, horizontal selection of two buttons horizontally adjacent to a US patent number in the workspace generates a link to the US Public PAIR search page, while selection of the same two buttons horizontally adjacent to text in the workspace, converts the text to a hyperlink for using the text as an advanced search string in the USPTO database. In another illustrative embodiment, chords 146 include a horizontal selection of two or more buttons and selection of a data element in the workspace 102, where the data element can include a hyperlink to a database. That is, the data element is included as part of a chord. In one further embodiment including four columns of buttons and selection of a data element in the workspace 102, fifteen different selections are available for calling software, generalizing to N+N(N+1)/2 possible chordal selections.

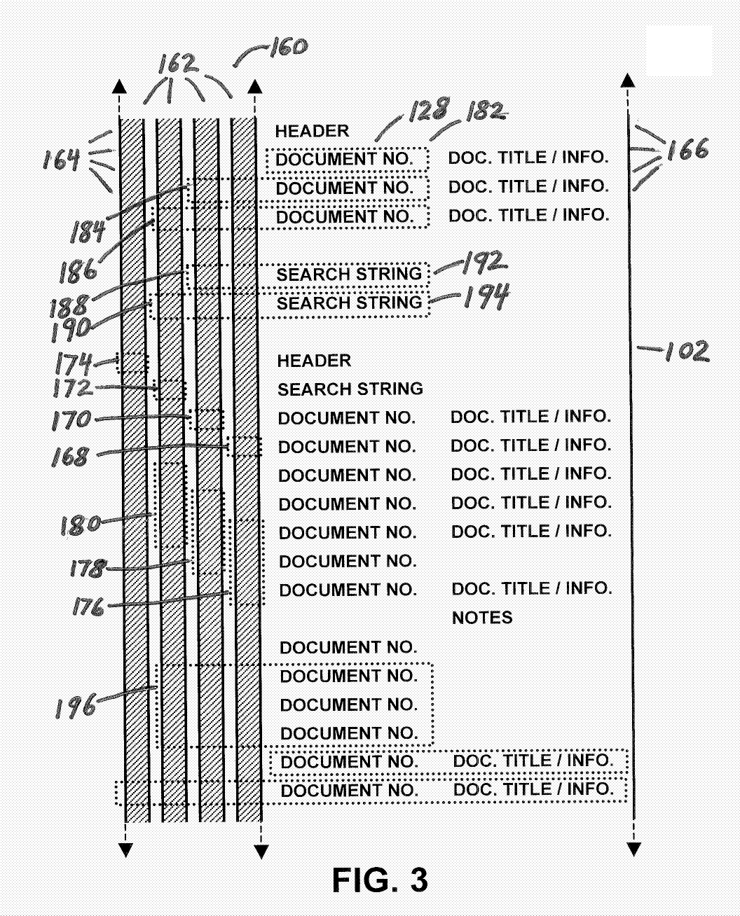

FIG. 3 illustrates the workspace 102, accompanied by a control bar-type control area 160 that includes a plurality of vertical control bars 162. The bar-type control area 160 has substantially the same functionality as the discrete button control area 140 of FIG. 2, except that instead of individual buttons 142, vertical segments 164 of each of the plurality of vertical control bars 162 is adapted to function as software buttons for adjacent data rows 166 in the workspace 102. In an embodiment, one or more of the plurality of bars 162 is vertically continuous in appearance in the GUI 100. FIG. 3 illustrates each of the plurality of vertical bars 162 as visually continuous. The plurality of bars 162 can provide a less visually cluttered aspect of the GUI 100 than a larger plurality of individual buttons 142 having substantially equivalent functionality. The plurality of bars 162 can be visually coded with respect to one another to simplify recognition of an individual bar by a searcher using the GUI. Coding can be by pattern, by color, or by another means, and can be changed with context. In an embodiment, the plurality of vertical bars 162 is color coded.

Further considering FIG. 3, in an illustrative embodiment, the plurality of vertical bars 162 comprises four vertical bars that are each individually selectable at a plurality of vertical positions along the bar. The plurality of positions can function as a continuous selection area, for example, by comprising a column of spreadsheet cells. Exemplary manipulations of data in a plurality of rows corresponding to the plurality of positions includes deleting 168 a row of data from the workspace 102, restoring 170 a previously deleted row to the workspace 102, inserting 172 an empty row into the workspace 102, or formatting 174 data in the workspace 102. In an embodiment, restoring 170 a previously deleted row comprises copying data to the deleted row from a data storage register into the workspace 102. In an embodiment, formatting a data row includes one or more of adjusting font formatting, parsing a data record that has been pasted into the workspace to extract reference information, and generating a hyperlink to a source document in an on-line database.

In addition, each of deleting 168, restoring 170 and inserting 172 can be applied to a plurality of data rows by selecting a corresponding plurality of positions (buttons) 176, 178, 180 vertically along the respective one of the plurality of bars 162. In an embodiment, formatting 174 generates one or more hyperlink 182 to or more document in an on-line database, referenced by a respective one or more document number 128 in the workspace 102. In an embodiment, formatting includes parsing a test string in the workspace to determine whether the string as contains a document number and, if so, generating a hyperlink to an associated on-line database. Selecting the hyperlink 182 provides access to the referenced document by following the hyperlink. Any document number 128 illustrated in FIG. 3 can be assigned a hyperlink. Other types of data elements can also be assigned hyperlinks

In another embodiment, chordally selecting horizontally (along a row) calls software to redirect a hyperlink in the workspace 102. In an embodiment, as illustrated hereinabove 184, 186, a chordal selection includes selecting a data element of a database record in the workspace 102. In an embodiment, selecting a horizontal chord redirects a hyperlink associated with a document number in the workspace 102 from a first database to a second database, and selecting the redirected hyperlink follows the hyperlink to the second database. In a still further embodiment, selecting anywhere in the GUI except the redirected hyperlink again redirects the redirected hyperlink from the second database to the first database.

In one embodiment, selecting a first horizontal chord calls software to redirect a hyperlink from a patent number search page to the USPTO Public PAIR search page. In another embodiment, selecting a second horizontal chord calls software to redirect a hyperlink from a patent number search page to the USPTO assignments database. In yet another embodiment, a hyperlink is redirected to an international patent search page. In other embodiments, chordal selection calls software to redirect a hyperlink to a commercial intellectual property database. In an embodiment, selection among databases for accessing documents and for database searching is determined contextually in association with a software call and by interpreting a document number. In one embodiment a prefix of “WO” associated with a document number, directs a link to the WIPO website, while a prefix of “US” or lack of a prefix directs the link to the USPTO website. In addition, the length and content of the unprefixed document number is used for directing the link between a patent database and a published application database.

In an embodiment of software calling using chordal selection in the workspace, a chord is selected from the group consisting of a data element and horizontal selection across one or more vertical bar 162. Software called by the selection identifies the type of data in the data element. In an embodiment, the type of identifiable data is one of a U.S. patent number, a U.S. published application number, a WIPO (PCT) publication, and a text string. The software also identifies a chord type. In an embodiment, the chord type is one of the data element (singly selected), a chord consisting of the data element and two vertical columns, and a chord consisting of the data element and three vertical columns. The software then performs operations using the data element, the specific operations being selected based on the combination of data type and chord type. In an embodiment the operations are selected using a lookup table including the data type and the chord type.

Software called by selecting an individual button or selecting a chord can be called contextually, for example, by a data type in the workspace. In an embodiment, selecting a third 188 or a fourth horizontal chord 190 having the same physical configuration as the first 184 or second horizontal chord 186 converts a corresponding search string 192, 194 from text to a hyperlink directed to a corresponding search page in an on-line database. Thus a chord used to call software to redirect a hyperlink in the workspace 102 can also be used to contextually call different software to generate search string link, depending on the type of data comprising a data element in the workspace. In still another embodiment, a rectangular chord 196 includes a rectangular selection in a plurality of rows and a plurality of columns. In a further embodiment, selection of the rectangular chord 1196 calls software for manipulating a corresponding plurality of rows of data in the workspace. In a still further embodiment, manipulating the corresponding plurality of rows includes concatenating data elements from the plurality of rows, into a search string for searching a database.

The examples hereinabove of individual button, bar and chordal selection are meant to be illustrative of the versatility of the GUI 100, and not limiting of individual functions or assignments of software calls associated with individual or chordal selections of buttons. Any combination of buttons in the control area 106, 140, 160 can comprise a chord. Further, chords can extend beyond the control area into the workspace, as illustrated hereinabove. In another embodiment, a chord includes two or more buttons selected diagonally in the control area. In a preferred embodiment, chords comprise two or more horizontally or vertically adjacent buttons in a line, or a rectangular selection of buttons. For chordal input using a computer mouse, a trackball or a related input device, adjacent-button chords can be more convenient to use than chords comprising nonadjacent selections of buttons. This convenience derives in part from mouse-type devices providing “dragging” for concurrent selection of several graphical elements in an interface. Some types of touchscreen or related input devices that can concurrently or in rapid sequence sense separated buttons in an interface, can provide enhanced convenience for using chords comprising nonadjacent buttons.

Software called by individual or chordal selection of buttons in a control area, or elsewhere in a GUI of the present invention, can be written in any programming language useful for creating a graphical user interface, and can be programmed using programming methods known to those having ordinary skill in this art. Capabilities required of the programming language include string and numerical operations, establishing and modifying hyperlinks, and graphical and formatting operations to establish and support the structure of the GUI. Graphics that are displayed in the GUI can be programmed using an independent programming language, or adapted to operate as a module within an environment established by another program. Nonlimiting examples of programming languages suitable for writing software to generate a GUI of the present invention include, but are not limited to, Visual Basic, Visual Basic for Applications, C++, PERL, and Real Basic.

In an exemplary embodiment, the GUI operates in the Microsoft Excel spreadsheet environment, and software to automate the GUI is written in the Visual Basic for Applications (VBA) programming language. Both Microsoft Excel and Visual Basic for Applications are products of Microsoft Corporation (Redmond, Wash.). In one embodiment, chords comprise one or more adjacent spreadsheet cell in a Microsoft Excel spreadsheet, and the software includes a VBA “Worksheet_SelectionChange” statement (which is included with the VBA programming language) that detects selection of the chord to initiate a response to chord selection, that is, selection of the one or more cell comprising a chord.

Hyperlink creation and use are commonplace in internet-enabled software and computer systems. Several methods for software button programming are also known. In one embodiment, software buttons comprise drawing objects embedded in an electronic document. In another embodiment, software buttons are associated with a fixed location within an electronic document. In a further embodiment, the electronic document is a spreadsheet and the fixed location is one or more spreadsheet cell. Contextual selection of software routines based on data content is also known in the programming art. In one embodiment, a hyperlink is directed to a database that is selected on the basis of interpreting alphameric characters present in the data. In one further embodiment, leading alphameric characters in a document number are interpreted as a Country Code for selecting a patent database and for selecting a direction of a hyperlink. In another further embodiment, a numerical value of a document number is used to determine the direction of a hyperlink, that is, the internet address accessed by the hyperlink. In one embodiment, a hyperlink links directly to a document in an on-line database. In another embodiment, a hyperlink is directed to a document number search entry page of the on-line database, for entering data copied from the workspace.

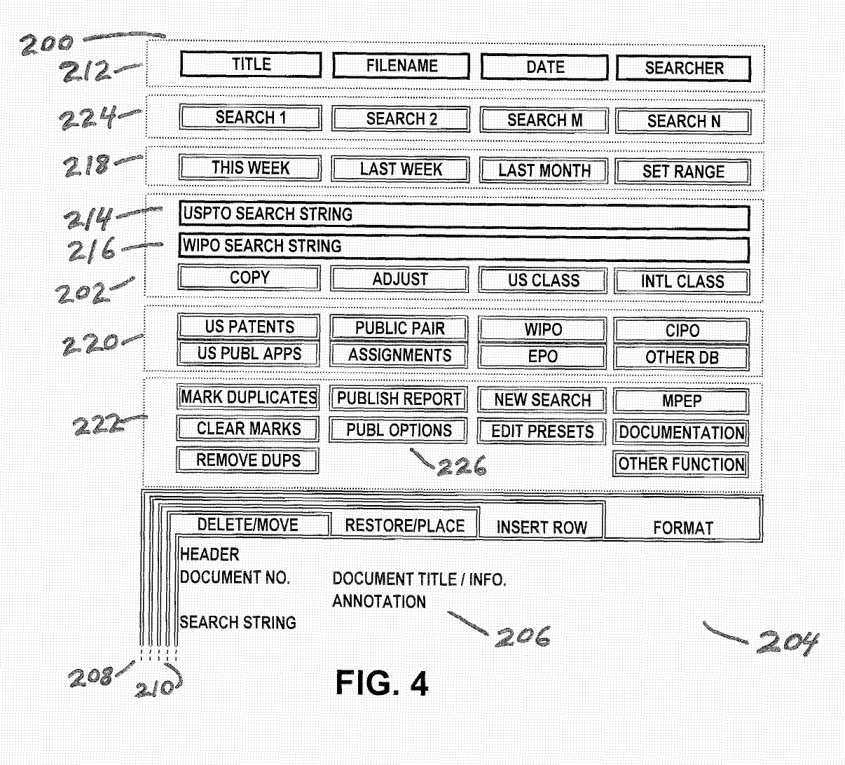

FIG. 4 shows illustrative embodiments of another GUI 200 of the present invention. The GUI 200 includes a general control area 202, a workspace 204 for placing and manipulating data 206, and a workspace control area 208. The workspace control area 208 can be the control bar type control area 160 of FIG. 3, the discrete button control area 138 illustrated in FIG. 2, or another configuration of controls for calling software to manipulate data 206 in the workspace 204. In an embodiment, the control area 208 includes four vertically oriented control bars 210. In a further embodiment, the control bars 210 are color-coded.

In an embodiment, the general control area 202 includes a plurality of controls and input fields for facilitating searching of on-line databases. Exemplary entry fields include identification fields 212 for one or more of a search title, a file name for publishing a search report, a date, and searcher identification. Exemplary entry fields also include fields for entering one or more search string 214, 216. In an embodiment, the general control area 202 includes an entry field for at least one of a USPTO database search string 214 and a WIPO search string 216. In a further embodiment, the general control area 202 includes software buttons for calling software to automatically add a range 218 of patent issue or document publication dates to the at least one search string 214, 216.

In an embodiment, the general control area 202 includes one or more hyperlink 220 to one or more on-line database. In one embodiment, the one or more on-line database is selected from among a national patent database, an international patent database, and a commercial patent database. An embodiment of the general control area 202 includes software buttons for calling software to perform general functions 222 including duplicate data identification and removal, publication of a search report, and user-definable functions. In another embodiment, the GUI 200 includes storage for a plurality of selectable workspaces, each of the plurality of workspaces adapted for independently conducting a search. In an embodiment, the general control area 202 includes a corresponding plurality of selection buttons 224 for calling software to display a selected one of the plurality of ongoing searches. The embodiments described hereinabove in association with FIG. 4 are intended to be illustrative rather than limiting of the functionality and layout of the GUI 200.

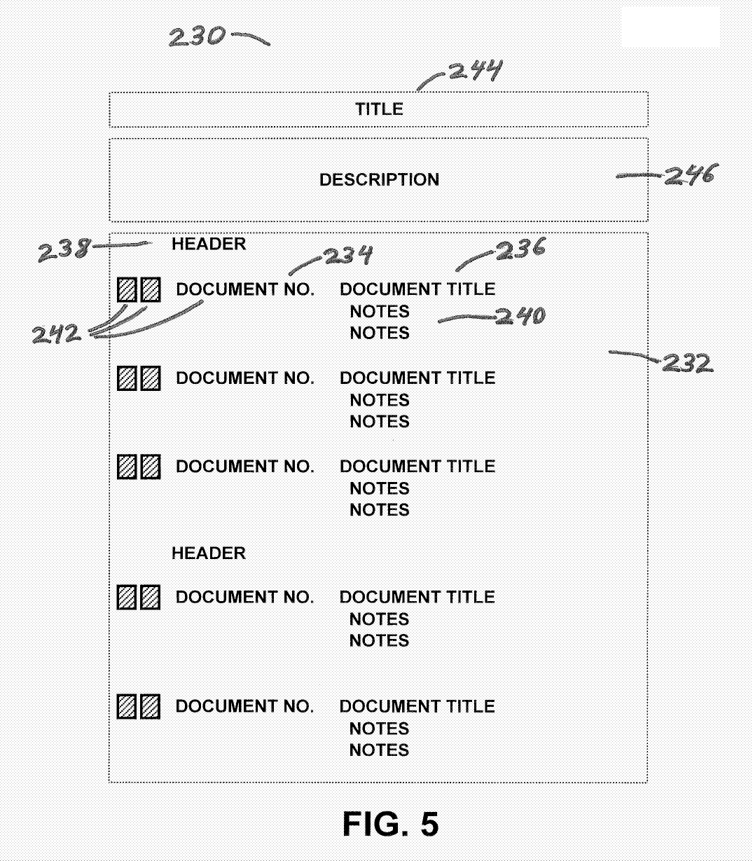

In an embodiment, the GUI 200 includes one or more publishing software button 226 to call software that formats and publishes data 206 from the workspace 204, to a report. In one embodiment the report is a published electronically as a software file. In another embodiment, the report is printed. An illustrative embodiment of a report 230 is provided in FIG. 5. The report 230 is seen to include data 232 copied from a workspace of the present invention. In an embodiment, the data 232 includes one or more of document numbers 234, document titles 236, data category headers 238, and annotation 240 that includes additional information concerning the data 232. The report 230 optionally includes hyperlinks 242 to one or more on-line database. In an embodiment, a document number 234 serves as a hyperlink 242 to the one or more on-line database. The report 230 is also seen to include one or more of a title 244 and descriptive information 246 about the report 230. In an embodiment, the report 230 is a periodically recurring report and the descriptive information 246 is placed automatically with each publication of the report 230. In an embodiment, the report includes hyperlinks to a plurality of international databases.

A GUI of the present invention is adapted to enhance the efficiency of on-line database searching. In one embodiment, a search is performed based on known search criteria that are stored as one or more established search string. This type of search is described herein as a preset search. In an embodiment, steps in performing a preset search include selecting an established search string, selecting a publication or patent issue date range in which to search, and selecting a hyperlink to an on-line database associated with the established search string. The established search string is then used to perform a search of the on-line database. One or more search result (for example, a plurality of database records) identified in the on-line database is copied to a workspace of the GUI. The one or more copied result is then formatted to individually include a hyperlink to a document in the on-line database. Additional established search strings can be selected and databases searched, in each case copying searched records to the workspace.

Database records in the workspace are then selected (for example, using a mouse click) by the searcher to explore the information they contain or by following a hyperlink to the associated on-line database. Software buttons in a control area of the GUI are selected as needed to redirect hyperlinks, sort, delete, annotate and otherwise manipulate the search results until the search is complete. In an embodiment, a report can then generated by selecting a software button to call publishing software. In an embodiment, selecting a hyperlink calls software to place a search string, a document number or another data element into the clipboard to make that data element available for pasting into an entry field for the on-line database.

In another embodiment, new search criteria are established to perform a search. This type of search is described herein as a general search. In one embodiment, steps in performing a general search include entering a search string in an entry field of the GUI, and selecting a hyperlink in the GUI to an on-line database associated with the search string for performing a search. The search string is then used to perform a search of the on-line database. One or more search result (for example, a plurality of database records) identified in the on-line database is copied to a workspace of the GUI. The one or more copied result is then formatted to individually include a hyperlink to a document in the on-line database. The search string is then edited as needed or additional search strings are entered for searching the on-line database or another on-line database, in each case copying searched records to the workspace. In an embodiment, the search string used for a search is copied automatically to the workspace for use as a header for search results copied to the workspace. In an embodiment, selecting a hyperlink calls software to place a search string, a document number or another data element into the clipboard to make that data element available for pasting into an entry field for the on-line database

Many variations of the searching methods described hereinabove are possible within the scope of the present invention. For example, the USPTO on-line patent database includes a list of prior art references along with a text representation of an issued patent. In an embodiment of a method of using a GUI of the present invention, the list of prior art references is copied to the workspace. The copied list is then formatted within the workspace, thereby generating hyperlinks for incorporating the patents therein into an ongoing search. In an embodiment, the referenced documents include U.S. and foreign references. In another embodiment, a plurality of search strings is used to search an on-line database, and search results obtained using each of the plurality of search strings are copied to the workspace. Duplicate records are then identified within the workspace using duplicates identification software, to narrow the search.

A system of the present invention for on-line database searching includes a computer workstation. The workstation can be a personal computer, a workstation associated with a larger computer system, or any electronic device that includes a display and access to one or more on-line database. The system also includes a GUI of the present invention for accessing the on-line database. In one embodiment, the system includes a personal computer, a pointing device, a keyboard and a display monitor. In another embodiment, the system includes a portable computer with integrated keyboard, display and pointing device. In an embodiment, the system further includes a spreadsheet program installed in the workstation. In addition, the GUI of the present invention can be stored using any suitable computer file storage medium. Suitable media are volatile or nonvolatile and include but are not limited to portable and internal computer hard drives, optical, magnetic, or electronic recording media including compact disks (CDs), digital video disks (DVDs), flash memory drives and removable magnetic media.

GUIs and associated methods and systems of the present invention have many advantages. These advantages include but are not limited to advantages associated with effective and efficient searching of a plurality of on-line databases, efficient storage and distribution of search results, and reducing connect time to on-line databases during performance of a search. A GUI of the present invention provides a common working environment for coordinating the searching of a plurality of databases, thereby dramatically reducing the time cost of searching while enhancing the searcher's ability to collate and interpret search results. The present invention also provides a consistent format for search result data obtained from different databases.

Chordal selection of software functions within the database provides an uncluttered work environment, further enhancing work efficiency for the user. Somewhat analogous to the playing of a stringed musical instrument, straightforward chords are generally easy for the user to remember and to translate (or transpose, to continue the musical analogy) among software buttons positioned along and adjacent to the workspace. The chordal interface dramatically reduces the complexity of calling a variety of specialized software routines, compared with the hierarchal command trees of the typically menu-driven graphical interfaces known in this art. These features provide a very fast learning curve for new users of the GUI, rendering it uniquely useful to inexperienced, as well as experienced searchers.

In addition, storage of search results produced using the GUI provide links to documents or document lookup pages in referenced databases, rather than requiring local storage of entire searched documents for access to their contents. Another advantage of the present invention is its provision of access to a plurality of databases from a single location, using a single interface and computer or workstation. In addition, by generating links to lookup pages of databases rather than directly to documents, address changes of, or within on-line databases can be readily updated using GUIs of the present invention, since only the lookup page address needs updating, rather than updating an individual address associated with each hyperlink in a report. Thus the possibility of reports becoming obsolete as on-line databases change their internet addresses is dramatically reduced.

Yet another advantage is that a GUI of the present invention enables efficient individual and coordinated searching of a plurality of primary on-line databases, for example, databases provided by various governmental patent offices. Further, this searching can include access to sophisticated search functions typically available only in commercial, secondary source databases. For example, overlapping results from a plurality of searches can more easily be identified in a single workspace of the present GUI than from multiple, independent searches. Further, by providing simultaneous display of search strings for a plurality of databases, enhanced coordination is achieved among searches in databases differing with respect to search syntax requirements. Still another advantage of the present invention is automated publication of a search report directly from a workspace for performing a search.

A GUI of the present invention advantageously enables a searcher to perform downselection of search results on a local computer or workstation rather than on-line, thereby reducing the length of time the searcher is accessing the on-line database, reducing the number of documents that may ultimately be downloaded, and reducing the user load on the database. In addition, a GUI of the present invention enables a searcher to coordinate a plurality of searches in parallel. In an illustrative embodiment, the GUI includes six active searches, each search using unique search criteria, with selection among the active searches performed by a single mouse-click.

A GUI of the present invention can also be easily portable. In an illustrative embodiment, A GUI of the present invention, including VBA support software for operation within a spreadsheet environment, comprises a spreadsheet file occupying approximately 1 Megabyte of computer memory, including the recording of six patent searches in progress, each holding fifty data records including hyperlinks. In another illustrative embodiment, a search report published using a GUI of the present invention and including annotated links to fifty documents in U.S. and international on-line databases comprises a spreadsheet occupying less than 50 kilobytes of memory.

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A graphical interface for searching one or more electronic database, the interface comprising:
a) A substantially rectangular workspace for displaying a plurality of database records from the one or more database, the workspace having a vertical edge; and
b) a plurality of software buttons defining a substantially rectangular button array positioned adjacent to the vertical edge, two or more buttons of the array being adapted for concurrent selection, the concurrent selection being operable to selectively call a software routine for manipulating one or more record of the plurality of records.

2. The graphical interface of claim 1 wherein the two or more buttons are selected from the group consisting of two or more horizontally adjacent buttons, two or more vertically adjacent buttons, and four or more adjacent buttons in a rectangular pattern.

3. The interface of claim 1 wherein the button array includes two or more vertical columns of buttons, a button in each of the two or more columns being individually selectable for calling a software routine.

4. The interface of claim 1 wherein the two or more columns are color-coded with respect to one another.

5. The interface of claim 1 wherein the one or more database is a patent database.

6. The interface of claim 1 wherein the one or more database includes at least four databases.

7. The interface of claim 1 comprising a spreadsheet.

8. A graphical interface comprising:
a) a workspace for displaying a plurality of data-containing records; and
b) a plurality of software buttons positioned adjacent to the workspace and defining a two-dimensional button array, a software button of the array being adapted for concurrent selection with a first adjacent button of the array for calling a first software routine, the software button being adapted for concurrent selection with a second adjacent button of the array for calling a second software routine distinct from the first software routine, each of the first and the second software routine adapted for manipulating one or more record of the plurality of records.

9. The graphical interface of claim 8 wherein the two-dimensional button array is substantially rectangular.

10. The graphical interface of claim 8 wherein the software button and the second adjacent button are adapted for concurrent selection with a third adjacent button of the array, for calling a third software routine distinct from the first and the second software routine, the third software routine adapted for manipulating one or more record of the plurality of records.

11. The graphical interface of claim 8 wherein a record of the plurality of records includes a hyperlink to an on-line database.

12. The interface of claim 8 comprising a spreadsheet.

13. A system for facilitating searching a plurality of electronic databases, the system comprising:
a) a computer workstation having electronic access to the plurality of databases; and
b) a graphical interface installed on the workstation, the interface including a substantially rectangular workspace for holding a plurality of records downloaded from one or more of the plurality of databases, and a rectangular array of software buttons positioned substantially adjacent to the workspace, at least two buttons of the array being adapted for selection individually and chordally for selectively calling software routines for manipulating one or more of the plurality of records.
